(19) United States
(12) Patent Application Publication
(10) Pub. No.: US 2007/0243861 A1
(43) Pub. Date: Oct. 18, 2007

(54) Method and Module for Software Updating of a Gateway Between a Network Operator and a Local Area Network

(76) Inventors: Cedric Hutchings, Levallois (FR); Clement Moreau, Paris (FR); Eric Carreel, Meudon (FR)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(21) Appl. No.: 11/628,936

(22) PCT Filed: Apr. 1, 2005
(86) PCT No.: PCT/FR05/00800

§ 371 Date: Dec. 7, 2006

(30) Foreign Application Priority Data
Jun. 9, 2004 (FR) 0406243

(51) Int. Cl. H04L 29/06

(52) U.S. Cl. 455/414.3

(57) ABSTRACT

The invention concerns a method for software updating of a system comprising an operator's network and local area networks including respectively terminals equipped with a user interface, and a gateway device connected to the operator's network and setting up, upon request from the user of a terminal, an access channel to the services, the gateway device not being provided with user interface for accessing the services and comprising a set of software applications, said method comprising a preliminary step during which an event is triggered to transmit, over a communication channel set up in response to a user request, a message concerning said updating and to communicate the message to the user via the terminal and a step of downloading towards the gateway device an updating of the set of software applications.

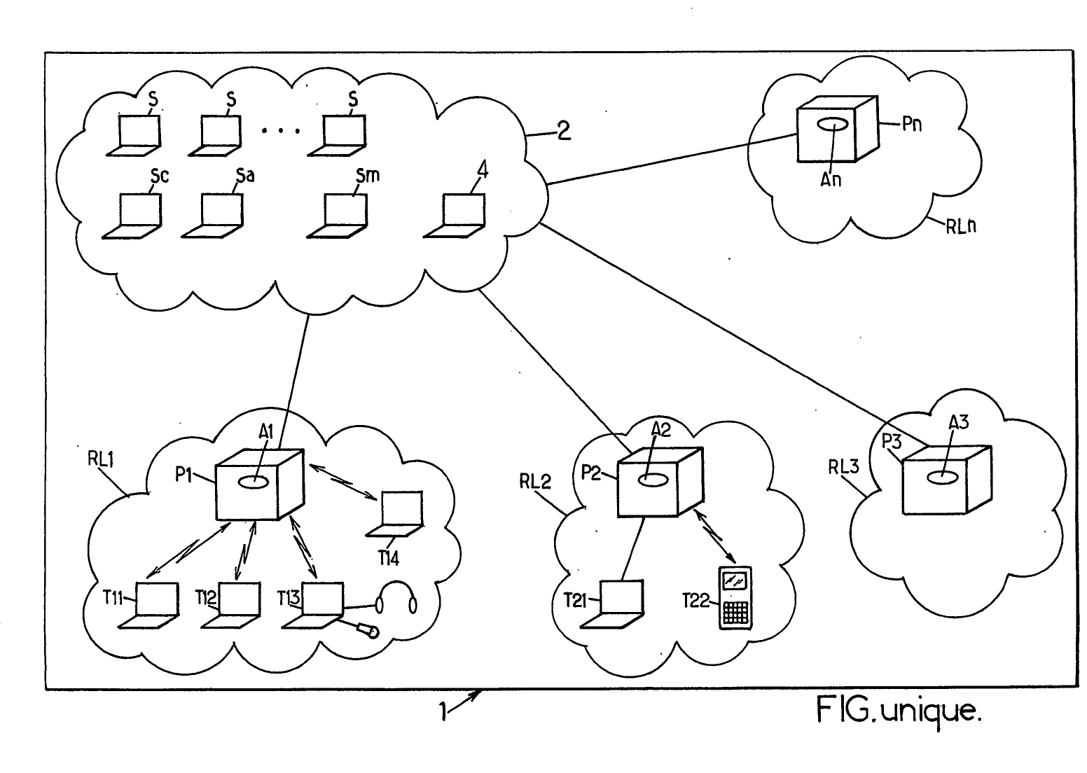

The present invention relates to the domain of systems comprising the network of an operator and terminals. The operator's network delivers services to subscribers. The subscribers have access to these services from user interfaces with which the terminals are fitted.

The services provided by the operator are for example TV broadcasting, voice over IP, Internet navigation, etc.

More specifically, the present invention deals with cases in which a gateway device is situated between the operator's network and the terminal or terminals of a same subscriber. For example, for a same subscriber, two fixed PCs (personal computer), a mobile computer, a PDA (Personal Digital Assistant) are connected via a local area network to the gateway device.

Upon a request from the user for access to the services provided by the operator that is set up from the user interface of the terminal operated by the user, the gateway device sets up a communication channel between the operator network and the user, by which channel the user has access to the services.

The gateway device is not provided with a user interface enabling the services supplied by the operator to be used by user. This use is solely from the user interfaces of the terminals.

A gateway device comprises among other elements a set of software applications. Some of these software applications are run for example when setting up a communication channel required by a user. Others relate to exchanges between the operator's network and the gateway device itself, independently from the consultation of the services by the operator. For example, they relate to maintenance operations or even to the configuration of the gateway, notably to set the characteristics of the channel to set up (speed, maximum authorized failure threshold, etc.).

The operator of the service network must regularly download new software applications or updates of software applications already installed onto the gateway devices installed with subscribers. For instance, such downloads can be realised to be able subsequently to deliver new services to the subscribers, such as broadband Internet, etc.

The gateway devices can, according to the cases, belong to the operator of the network or to the subscribers. In a system with a homogeneous set of gateway devices, all these devices belong either to the subscribers or to the operator. In a system with a heterogeneous set of gateway devices, some of the gateway devices belong to the subscribers, others belong to the operator.

This is why the download of applications intended for gateway devices cannot be systematically carried out in an automatic manner, as was the case for example for the network routers.

It is necessary to be able to account for the fact that a device belongs to a subscriber, and in that case, the subscriber may have the right to refuse a download or require to be informed beforehand of the operations carried out on his gateway. However, the gateway does not have any interface means with the subscriber.

In order to solve this problem, the present invention proposes, according to a first aspect, a method for updating a system comprising an operator network providing services to users and at least one local area network.

Each local area network comprises at least one terminal with a user interface, which enables the communication with a user of the said terminal. Each local area network also comprises a gateway device connected to the network of the operator and setting up, upon the request of the user of a terminal in the said local area network, a communication channel between the network of the operator and the user. The communication channel thus set up enables the user to access the services provided on the operator's network. The gateway device is not provided with a user interface for access to the said services and comprises a set of software applications.

The method comprises at least one step of updating all the software applications on the gateway device of a local area network. This updating step comprises at least one preliminary step during which an event is triggered to transmit, over a communication channel set up in response to a user request, a message concerning said updating and to communicate the message to the said user by means of the user interface of the terminal.

Moreover, the method comprises a downloading step during which an update of all the software applications is downloaded onto the gateway device.

Such a method can thus realize the software updates downloaded by the operator into the gateway devices, within systems with a heterogeneous or homogeneous set of gateways, while allowing the subscribers to be informed and/or requesting their agreement on this update.

By update of all the software applications of the gateway device, it is meant the downloading of one or more new software applications onto the device, or even the updating by the downloading of one or more software applications already present in the gateway device, or even the remotely controlled removal of one or more software applications present in the device.

In particular embodiments, the method comprises one or more of the following arrangements:
the message is a request concerning the agreement of the user to the updating of all the software applications of the gateway device of the local area network,
the updating of all the software applications of the gateway device is only carried out after the user communicates the agreement by input from the user interface of the terminal and sent by means of the communication channel,
beyond a set period, the update of the set of software applications of the gateway device will be carried out even without the agreement of the user,
the user will also be identified during the communication of the agreement,
the services provided by the operator include the Internet connection,
the update of all the software applications of the gateway device is carried out automatically.

According to a second aspect, the invention proposes a module for updating the software of a system comprising an operator's network providing services to users, and at least one local area network. Each local area network comprises at least one terminal with a user interface able to communicate with a user of the said terminal, and a gateway device connected to the operator's network. The gateway device sets up, upon the request of the user of a terminal in a local area network, a communication channel between the operator's network and the user, enabling the user to access the services provided on the operator's network. The gateway device is not provided with a user interface for access to the said services and comprises a set of software applications. The update module according to the invention comprises means for implementing a method according to the first aspect of the invention.

Other characteristics and advantages of the invention will emerge from reading the following description. The description is purely illustrative and must be read in relation to the annexed drawings wherein:

the single FIGURE shows a system in an implementation mode of the invention.

In reference to the single FIGURE, a system 1 comprises the network 2 of a service operator delivering different services to its subscribers in accordance with the options chosen by these subscribers. Among the services proposed are Internet navigation packages (10 hours/month, unlimited), a voice over IP service, a video on demand service, etc.

The network 2 of the operator comprises many communications servers S adapted to provide all the services. It also comprises application servers Sa, file configuration servers Sc and messaging servers Sm.

The operator provides services to many subscribers. Each subscriber has a local area network RL. A local area network RL comprises a gateway P and at least one user terminal T.

The gateway P of a local area network has a link with the operator network 2. This link allows exchanges between the operator network 2 and the gateway P of a local area network and contributes to the supply of services to the subscriber.

Each gateway P has a certain number of software applications required for it to operate. This set of software applications will globally be named “A”.

It also comprises configuration files defining the ownership of the gateway (owned by the operator or the subscriber), and the profile of the subscriber, among other things. The Sc configuration servers update these configuration files from the operator's network 2.

The gateway P of a local area network is, moreover, linked to each terminal in the local area network.

Moreover, the operator network 2 comprises a server 4 with which the gateways P1 . . . Pn are in regular contact. This consultation allows the operator network 2 to provide the gateways regularly with instructions relating to the loading of software applications by the application server Sa, to the configuration modifications to be performed by the configuration server, etc. required for the correct operation of the network 2.

At least some of the user terminals are equipped with a user interface. A user of a local area network requires, by means of the user interface of a terminal, access to a subscribed service. In response to this request, exchanges in relation to the verification of the rights of the subscriber occur between the gateway P and the operator network 2, then if necessary, the gateway P sets up a communication channel between the subscriber and the network 2, enabling the required service to be provided for the user.

In the single FIGURE, the local area networks RL₁, RL₂ . . . RLₙ of n subscribers is shown. Each local network RLᵢ has a gateway Pᵢ with respective software applications Ai and k terminals Tij_{ij=1 to k}. The RL1 network comprises four terminals T11, T12, T13 and T14. The network RL1 also has the gateway P1. The terminal T11 is a fixed PC, the terminal T12 is a mobile computer, the terminal T13 is a PC with headphones and a microphone. The terminal T14 is a printer. The subscriber corresponding to the local area network RL1 has Internet navigation and telephony services provided by the operator of the network 2.

The gateway P1 comprises the software applications grouped under the name A1. It is connected to each of the terminals with a Wi-Fi link for example.

The gateway P1 belongs to the subscriber of the network RL1.

The network RL2 has two terminals T21 and T22 and a gateway P2. The terminal T21 is for example a fixed PC. The terminal T22 is a PDA.

The PC T21 is for example connected to the gateway P2 by a wire link, whereas the PDA T22 is connected to the gateway P2 with a Bluetooth connection.

The gateway P2 comprises software applications grouped under the name A2. It belongs to the operator of the network.

In one embodiment of the invention, following the identification and correction of a serious malfunction of a basic software application present in the sets of software applications of all the subscriber gateways, the network operator decides to update the gateways of all the subscribers.

For this purpose, an informational message relating to an imminent download of a new version of a residual application onto the gateways is prepared in the Sm messaging server of the operator's network 2.

The gateways P1 to Pn, during the exchanges with the server 4 are capable of being configured by the configuration servers Sc, so that the informational message is presented to the next user of each local area network who requests access to the services of the operator. This configuration notably comprises storing the address of the message to present in a non-volatile memory that the gateway contains, the message being stored in the messaging server Sm of the operator's network 2.

In one embodiment of the invention, the configuration of the gateway can include the storage, in a memory (volatile or non-volatile) of the gateway, of the message itself to present.

Hence, in reference to the single FIGURE, when a user connects to the terminal T11 to navigate on the Internet, he will see a window appear on his screen informing him of the imminent realisation of an update, the corresponding message being presented by the gateway (it will have searched for it either directly from one of its memories or from the address notified in the server Sm).

In particular embodiments of the invention, the user could for example be prompted to run this update immediately or defer it.

In other embodiments of the invention, the time of the update will be decided upon exclusively by the operator.

The update will be realised by downloading the software application from the applications server Sa to the gateways P1 . . . Pn. Following this download operation, the set of software applications A₁ . . . An of each gateway is updated

According to the embodiments, the information can only be communicated once, and this on the terminal of the user on which the first access to the services occurred after the information notification operation by the operator. On the contrary, it could be communicated only once, but to all the terminals by means through which there is access to the services. In one embodiment of the invention, the information can be communicated during each access to the services for a given period, etc.

The informational message can be communicated in forms suited to the services required: for example a voice message on terminal T13.

In another embodiment of the invention, the operator of the network 2 can, before proposing a new service to its subscribers (for example an increase in the capacity of the communication channel), decide on the necessity of downloading a new software application onto the gateways.

Even if this new software application will only be useful, finally, to the subscribers who will subsequently choose this new service, the operator wants to update all the gateways so as to have a minimum of software application versions to maintain.

However, in the case considered, it does not want to make these modifications on the gateways belonging to the subscribers without the agreement of these subscribers.

Hence a first message and a second message are prepared in the messaging server Sm of the operator's network 2.

The first message is an informational and request for agreement message intended for the users of the local area networks for whom the gateway belongs to the subscribers and the second message is a informational message only intended for the users of the local area networks for whom the gateway belongs to the operator.

During the exchanges between the operator network and the gateway of a local area network, it will be determined, from gateway configuration files, that the first message must be sent to the gateway P1 and that the second message must be sent to the gateway P2 during access by a user to the services of the network 2. The messages will be communicated to the users in accordance with what has been described above.

A user of the local area network P1 during access to the operator's services will thus see a dialogue window open on the user interface of his terminal displaying the informational and request for agreement message. Concerning the updating of the software applications A1 contained on the gateway P1, he can confirm his agreement or signal his refusal by validating the relevant fields of the window open. His response is then sent to the network 2 by means of the communication channel. The updating can be immediate or deferred according to his choice.

As long as it has not been carried out, the immediate downloading of the new software application is for example proposed upon each access by a user. It is then finally triggered automatically at a maximum date and time set by the operator, on the gateways belonging to the operator.

For example, at a given date, the software applications A2 residing in the gateway P2 of the local area network RL2 are updated by downloading from the network, whether or not the users of the local area network are aware of the message.

Moreover, the downloading operation is not carried out on gateways belonging to subscribers who have refused or not supplied their agreement.

The downloading of the new software application onto a gateway belonging to a subscriber is triggered upon reception of the subscriber's agreement in response to the request for agreement.

In a particular embodiment, the user sending his agreement to the network 2 could be conditioned by the identification and authentication of the user (to prevent for example the children of the subscriber from accepting by validating the message without telling the subscriber).

In another embodiment, the system 1 can comprise several operator networks of service and the invention can be implemented using the same gateway device of a subscriber within the framework of the exchanges between the subscriber and one or more of these operator networks.

Selective downloads can be implemented according to one or more criteria such as the service subscribed or other parameters characterizing the profile of the users or even the technical characteristics of the gateway.

A software updating method as described above can thus download software applications onto gateway devices even in a heterogeneous set of such devices, enabling subscribers to be informed and/or obtain their agreement to these modifications.

1. Communication device comprising access means to an operator's network and access means to a local area network to which at least one terminal equipped with a user interface is connected, the said communication device not provided with a user interface, comprising at least one software application, and comprising means for updating the at least one software application, the said communication device being wherein it comprises:
means for receiving information from the operator's network concerning the availability of an update of the at least one software application,
means for transmitting to the said at least one terminal a message relating to the update so that the terminal displays it on its user interface; and
means for receiving an update of the at least one software application, through downloading.

2. Communication device according to claim 1, wherein the said message is a request concerning the agreement of the user for installing the update of the at least one software application on the said communication device.

3. Communication device according to claim 2, wherein the update of the at least one software application of the said communication device only occurs after communication of the agreement of the user entered through the user interface of the said terminal.

4. Communication device according to claim 3, wherein the user is identified during the communication of the agreement.

5. Communication device according to claim 2, wherein the updating is carried out without the agreement of the user, after expiry of the set period.

6. Communication device according to claim 1, wherein the said updating is carried out automatically.
